(19) United States
(12) Patent Application Publication
(10) Pub. No.: US 2010/0043200 A1
(43) Pub. Date: Feb. 25, 2010

(54) Method of manufacturing thin wall isogrid casings

(75) Inventors: Richard Green, Bristol (GB); Arthur P. Frost, Bristol (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 12/458,413

(22) Filed: Jul. 10, 2009

(30) Foreign Application Priority Data
Aug. 19, 2008 (GB) 0815018.7

(51) Int. Cl. B23Q 7/00

(52) U.S. Cl. 29/559; 269/287

(57) ABSTRACT

A method of manufacturing a thin wall isogrid or the like casing by a machining process comprising the steps of: mating a surface of a casing precursor (10,50) with a substantially continuous support surface (20,60) of a hollow support sleeve (18, 58); engaging an engagement surface (26, 66) of a deformation member (24, 64) with an engagement surface (22,62) of the support sleeve (18,58), the engagement surface (22, 62) of the support sleeve (18,58) being opposite the support surface (20,60) and the deformation member (24,64) being co-axially arranged with the support sleeve (18,58); axially displacing the support sleeve (18,58) and deformation member (24,64) relative to one another, the deformation member (24,64) engagement surface (22,62) and support sleeve (18,58) engagement surface (22,62) being configured such that the support sleeve (18,58) is deformed by the deformation member (24,64) by the relative axial displacement in order to mate the support surface (20,60) with substantially the whole of the surface (12) of the casing precursor (10,50) to be machined; and machining a plurality of recessed pockets in the said surface (12) of the casing precursor (10,50) opposite the surface (14,54) engaged by the said support sleeve (18,58); whereby the support sleeve (18,58) reacts loads acting on the casing precursor (10,50) by a machining tool during machining, thereby minimising distortion of the casing precursor (10,50) and tearing of the pockets being formed.

### FIELD OF INVENTION

This invention relates to isogrid casing structures.

In particular it relates to a method of manufacturing thin-walled isogrid casings by machining processes.

### BACKGROUND OF THE INVENTION

Isogrids are used for reinforcing thin-wall components such as gas turbine engine casings or for forming lightweight lattice type structures, for example for use in space vehicle applications. An isogrid is a structure which comprises a triangular pattern of ribs arranged in rows of equal sided triangles. Isogrids are used to increase the stiffness of thin-wall structures while minimising weight. Isogrids have found particular application in gas turbine aero engine applications where thin-wall engine casing ducts are reinforced with isogrids to provide additional stiffness for supporting ancillary units and components.

The minimum pocket wall thickness achievable with Numerically Controlled (NC) mill cutters and the like has been limited by distortion of the casing due to cutter induced stresses resulting in rupture and tearing of the thin wall pocket sections.

GB2387799 (by the same applicant) discloses a method of manufacturing a thin wall isogrid casing by a chip machining process. A substantially cylindrical casing is positioned on a support, the support having a substantially continuous cylindrical support surface engaging at least part of the inner or outer surface of the casing. A plurality of recessed pockets are then machined in the said inner or outer surface of the casing opposite the surface engaged by the support. The support reacts loads acting on the casing by the chip machining tool during machining to minimise distortion of the casing and tearing of the pockets being formed. However, this method requires a filler material to be provided between the casing and the support surface to fill gaps that occur between the casing and the support due to geometric differences between the casing and the support, for example due to manufacturing tolerances resulting in slightly oval casing cross sections. The filler material may shrink during curing and the component may expand during machining, causing gaps. Hence regions of the casing may not be properly supported after the casing and support have been mated.

GB2413977 (by the same applicant) also discloses a method of manufacturing a thin wall isogrid casing by a chip machining process. A frusto conical casing is mated with a support, the support having a substantially continuous frusto conical support surface engaging at least part of the inner or outer surface of the casing. During the mating process, the casing is deformed such that the support surface engages substantially the whole of the inner or outer surface of the casing. This method works well but only for frusto conical casings where the diameter of the casing varies along its length, allowing for a support of varying diameter to engage with substantially all of the surface of the casing.

Prior to the inventions described in the preceding two paragraphs it was not possible to manufacture isogrid reinforced casings where the pocket wall thickness is less than 1 mm other than by chemical machining, as described in U.S. Pat. No. 5,122,242 where it is mentioned that chemical machining can be used for producing pocket wall thicknesses and rib widths to a minimum of 0.5 mm.

In chemical machining metal removal is achieved by a reverse electro plating process which produces a metal hydroxide of the metal being removed suspended as an emulsion in the electrolytic solution. Removal and disposal of the metal hydroxide emulsion is both hazardous and expensive and this combined with other factors results in significant additional cost to the machined casing.

There is a requirement therefore for a method of producing thin wall section isogrid reinforced casings which avoids the use of hazardous chemicals, as in chemical machining, yet readily enables pocket wall thicknesses of 1 mm or less to be achieved without rupture or damage to the isogrid due to induced machining stresses.

### SUMMARY OF THE INVENTION

According to a first aspect of the invention there is provided a method of manufacturing a thin wall isogrid or the like casing by a machining process; the said method comprising the steps of:
mating a surface of a casing precursor with a substantially continuous support surface of a hollow support sleeve;
engaging an engagement surface of a deformation member with an engagement surface of the support sleeve, the engagement surface of the support sleeve being opposite the support surface and the deformation member being co-axially arranged with the support sleeve;
axially displacing the support sleeve and deformation member relative to one another, the deformation member engagement surface and support sleeve engagement surface being configured such that the support sleeve is deformed by the deformation member by the relative axial displacement in order to mate the support surface with substantially the whole of the surface of the casing precursor to be machined; and
machining a plurality of recessed pockets in the said surface of the casing precursor opposite the surface engaged by the said support sleeve; whereby the support sleeve reacts loads acting on the casing precursor by a machining tool during machining, thereby minimising distortion of the casing precursor and tearing of the pockets being formed.

According to a second aspect of the invention there is provided Machining support apparatus for use in manufacturing a thin wall isogrid casing or the like by a machining process; the said support apparatus comprising:
a hollow support sleeve having a substantially continuous support surface for mating with a surface of a casing precursor, and an engagement surface substantially opposite the support surface;
a deformation member with an engagement surface for coaxial location and engagement with the engagement surface of the support sleeve,
the deformation member engagement surface and support sleeve engagement surface being sized such that relative axial displacement of the support sleeve and deformation member will deform the support sleeve;
whereby, in use a casing precursor is mated with said support sleeve and the deformation member is coaxially engaged with the engagement surface, and the support sleeve and deformation member are axially displaced relative to one another, such that the support sleeve is deformed by the deformation member to engage the support surface with substantially the whole of the surface of the casing precursor to be machined, whereby the support sleeve reacts loads acting on the casing precursor by a machining tool during machining, thereby minimising distortion of the casing precursor and tearing of the pockets being formed.

This method and apparatus is advantageous since they provide a method and means for providing support over substantially all of a casing surface to be machined. The deformation member keys into the support sleeve and deforms the sleeve to engage with the casing precursor. The support sleeve is maintained in a fixed position relative to the casing throughout the process. That is to say, the support sleeve does not slide relative to the casing, since it is the action of the deformation member relative to the support sleeve which causes the deformation of the support sleeve. This eliminates the possibility of damage to the casing due to the relative motion between the casing and the support.

### BRIEF DESCRIPTION OF THE DRAWINGS

Embodiments of the invention will now be described with reference to the accompanying drawings, in which:

FIG. 1 shows an exploded view of a casing and a first embodiment of a machine support apparatus comprising a support sleeve and deformation member according to of the present invention;

FIG. 2 shows a close up exploded view of engagement features provided on engagement surfaces of the support sleeve and engagement member of the embodiment of FIG. 1;

FIG. 3a to 3e show how the engagement features of the support sleeve and deformation member engage;

FIG. 4 shows an exploded view of a casing and a second embodiment of a machine support apparatus according to of the present invention; and

FIG. 5 shows a close up exploded view of engagement features provided on engagement surfaces of the support sleeve and engagement member of the embodiment of FIG. 4.

### DETAILED DESCRIPTION OF EMBODIMENTS

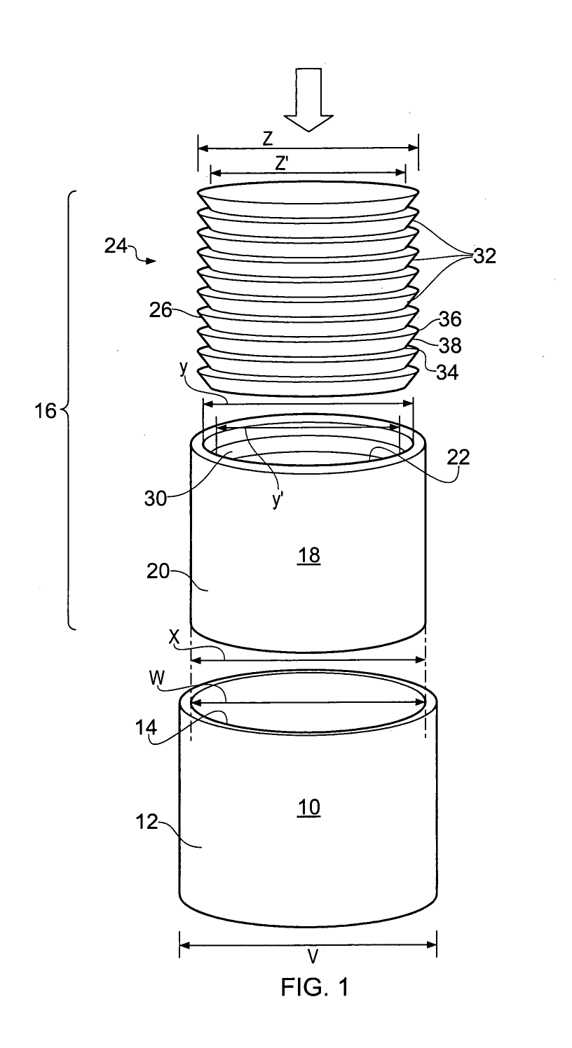

FIG. 1 shows a blank cylindrical casing precursor 10 to be machined by a machining process to produce a casing with an iso-grid structure on the outer surface 12 of the blank. The casing precursor 10 has an external surface 12 having a diameter v and an internal surface 14 of diameter w. The precursor 10 does not form part of the invention and is mentioned here merely to assist in describing the machining support apparatus 16 according to the present invention. The apparatus 16 comprises a hollow support sleeve 18 having a substantially continuous support surface 20 for mating with the internal surface 14 of casing precursor 10. The hollow support sleeve 18 is also provided with an inner engagement surface 22 substantially opposite the support surface 20. The (outer) support surface 20 has a diameter x. The (inner) engagement surface 22 of the support sleeve 20 has a maximum internal diameter y and a minimum internal diameter y′. The apparatus also includes a deformation member 24 with an engagement surface 26 for coaxial location and engagement with the (inner) engagement surface 22 of the hollow support sleeve 18. The deformation member 24 has a maximum external diameter z and a minimum external diameter z′. The deformation member 24 is of rigid construction and configured to retain its shape. It is substantially non-deformable.

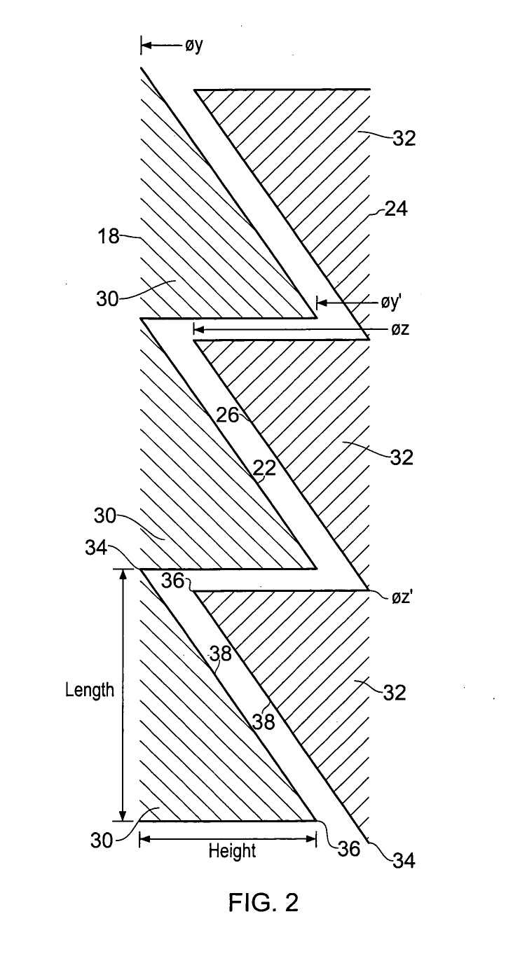

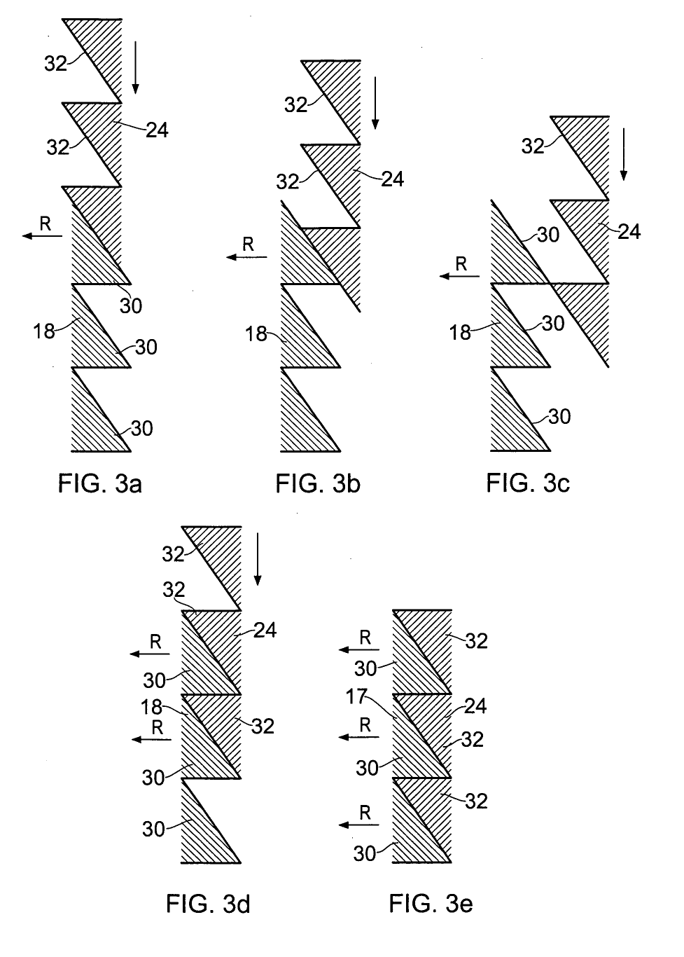

An enlarged view of the engagement surfaces 22,26 are shown in FIG. 2. The deformation member 24 is shown as if entered in the support sleeve 18. The engagement surfaces 22,26 are shown separated for clarity, but it will be appreciated that in practice, the surfaces 22,26 will be in contact with one another (as discussed later with reference to FIG. 3) since the deformation member 24 is “oversized” relative to the support sleeve 18. In the example shown, the engagement surface 22,26 of the support sleeve 18 comprises a plurality of ramps 30 which are complementary in shape to a number of ramps 32 provided on the engagement surface 26 of the deformation member 24. In other embodiments (not shown) each engagement surface is provided with only a single ramp 30,32. The ramps 30,32 each comprise a start point 34 and an end point 36 with an inclined region 38 of increasing height therebetween. The ramp height is defined as the difference in diameter between the start point 34 and any point on the inclined surface 38 between the start point 34 and the end point 36.

With the support sleeve in a non deformed state, the support sleeve 18 and deformation member 24 are sized such that there is at least a 1% difference in diameter between any point on the inclined surface 38 of the ramp 30 of the engagement surface 22 of the support sleeve 18 and a corresponding point on the ramp 30 on the engagement surface 26 of the deformation member 24.

Hence, in the embodiment shown in FIG. 1 the diameter of the inclined surface 38 of the ramp 32 of the engagement surface 26 of the deformation member will be 1% greater than a corresponding point on the ramp 30 on the engagement surface 22 of the support surface 22. Hence the maximum diameter z of the deformation member 24 is 1% greater than the maximum internal diameter y of the support sleeve 18. That is to say the diameter z at an end point 36 on a ramp 32 of the deformation member 24 (i.e. at the maximum diameter z of the deformation member 24) will be 1% greater than the diameter y at a start point 34 on a ramp 30 of the support sleeve 18 (i.e. at the maximum internal diameter y of the support sleeve 18). Likewise, the diameter z′ at a start point 34 on a ramp 32 of the deformation member 24 (i.e. at the minimum diameter z′ of the deformation member 24) will be 1% greater than the diameter y′ at an end point 36 on a ramp 30 of the support sleeve 18 (i.e. at the minimum internal diameter y′ of the support sleeve 18). Likewise, all points along the inclined region 38 between the start point 34 and end point 36 of a ramp 32 of the deformation member 24 will have a diameter 1% greater than the diameter at all points along the inclined region 38 between the start point 34 and end point 36 of a ramp 30 of the support sleeve 18.

The ratio of ramp 30,32 height at the end point 36 to ramp length is in the range of 1:5 to 1:10, where the ramp length is defined as the axial distance between the start point 34 and end point 36.

The diameter of each start point 34 and each end point 36 of successive ramps 30,32 on both engagement surfaces 22,26 is substantially constant along the axial length of the support apparatus 16.

In use, the support sleeve 18 is slid into the casing precursor 10 to mate its support surface 20 with the internal surface 14 of the casing precursor 10. The external diameter x of the support 18 is slightly less than the internal diameter w of the casing 10, and so there will be regions where the support surface 20 is not fully engaged with the internal surface 14. In order to fill any void between the support surface 20 and internal surface 14, the deformation member 24 is entered into, and then pushed through the support sleeve 18 until it extends through the entire length of the support sleeve 18. The outer dimensions of the deformation member 24 remain substantially constant, and the support sleeve 18 expands to allow the deformation member 24 to enter the sleeve 18. The casing 10, support sleeve 18 and deformation member 24 are co-axially arranged relative to one another, and share a common axis. In axially displacing the support sleeve 18 and deformation member 26 relative to one another, the support sleeve 18 is deformed by the deformation member 24 such that the support surface 20 engages with substantially the whole of the inner surface 14 of the casing precursor 10. As shown in FIG. 3a the deformation member 24 is pressed, for example by a hydraulic press, into the support sleeve 18 in the direction of arrow “A” in FIG. 3, which causes the sleeve 18 to expand radially outwards in the direction shown by arrow “R”. As the deformation member 24 is pushed further into the sleeve 18, as shown in FIGS. 3b and 3c, the support sleeve 18 is further radially deformed. The deformation member 24 is further pressed into the support sleeve 18 until the ramps 30,32 are engaged along a sufficient length of the precursor casing 10, as shown in FIGS. 3d and 3e. Thus the action of pushing the non deformable deformation member 24 through the sleeve 18 causes the sleeve 18 to expand radially such that it comes into contact with substantially all of the internal surface 14 of the casing precursor 10. The casing precursor 10 may be elastically deformed by the expansion of the support sleeve 18.

With such support in place, recessed pockets (not shown) may be machined in the external surface 12 of the casing. The support 16 reacts loads acting on the casing precursor 10 by a machining tool during machining, thereby minimising distortion of the casing 10 and tearing of the pockets being formed.

The casing precursor 10 is elastically deformed during the mating process with the support sleeve 18. This is to say, the machining support apparatus 16 expands (i.e. in this embodiment, deforms) the casing precursor 10 up to, but not beyond, the point at which it will elastically take up its previous internal diameter w when the machining support apparatus 16 is removed from the casing 10.

Using this method, the pockets machined in such materials may be machined such that they have a radial thickness of less than 1 mm. Preferably the said pockets are machined to have a radial thickness substantially in the range 0.45 mm to 0.85 mm.

The casing precursor 10 may be fabricated from sheet metal. Alternatively the casing precursor 10 is a forged casing.

In a non deformed state, the support sleeve 18 is sized such that there is a clearance gap in the range of 300 μm to 500μm between the support surface 20 and the casing precursor surface 14 it is to be mated to.

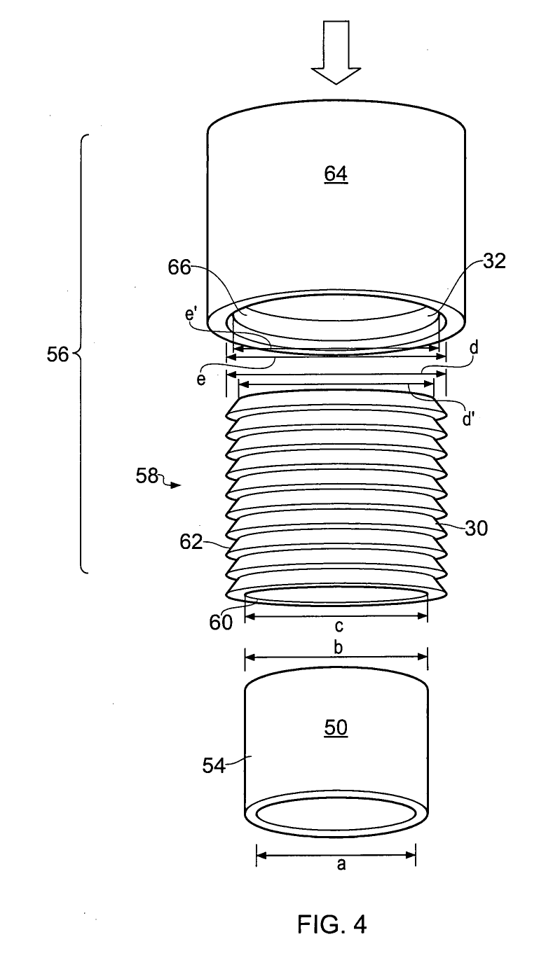

Shown in FIG. 4 is an alternative embodiment of a machining support apparatus according to the present invention for supporting a casing precursor 50 whilst it is machined on its internal surface 52. The internal surface of the casing precursor 50 has diameter a and the external surface 54 of the casing precursor 50 has a diameter b. The precursor 50 does not form part of the invention and is mentioned here merely to assist in describing machining support apparatus 56 according to the present invention.

The apparatus 56 comprises a hollow support sleeve 58 having a substantially continuous internal support surface 60 for mating with the external surface 54 of casing precursor 50. The hollow support sleeve 58 is also provided with an outer engagement surface 62 substantially opposite the support surface 60. The (inner) support surface 60 has a diameter c. The (outer) engagement surface 62 of the support sleeve 58 has a maximum external diameter d and a minimum external diameter d′. The apparatus 56 also includes a deformation member 64 with an engagement surface 66 for coaxial location and engagement with the (outer) engagement surface 62 of the hollow support sleeve 58. The deformation member 64 has a maximum internal diameter e and a minimum internal diameter e′.

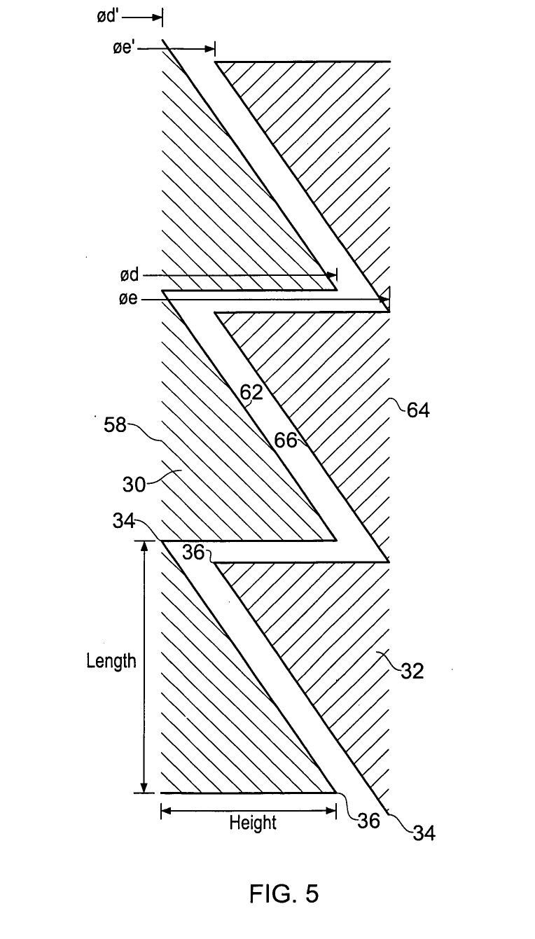

An enlarged view of the engagement surfaces 62,66 are shown in FIG. 5. The deformation member 64 is shown as if centred on the support sleeve 58. The engagement surfaces 62,66 are shown separated for clarity, but it will be appreciated that in practice, the surfaces 62,66 will be in contact with one another since the deformation member 64 is “undersized” relative to the support sleeve 58.

The diameter of the inclined surface 38 of the ramp 32 of the engagement surface 66 of the deformation member 64 is 1% less than a corresponding point on the ramp 30 on the engagement surface 62 of the support surface 62. Hence the maximum diameter e of the deformation member 64 is 1% less than the maximum external diameter d of the support sleeve 58. That is to say the diameter e at a start point 34 on a ramp 32 of the deformation member 64 (ie at the maximum internal diameter e of the deformation member 64) will be 1% less than the diameter d at an end point 36 on a ramp 30 of the support sleeve 58 (i.e. at the maximum external diameter d of the support sleeve 58). Likewise, the diameter e′ at an end point 36 on a ramp 32 of the deformation member 64 (i.e. at the minimum internal diameter e′ for the deformation member 64) will be 1% less than the diameter d′ at a start point 34 on a ramp 30 of the support sleeve 58 (i.e. at the minimum external diameter d′ of the support sleeve 58). Likewise, all points along the inclined region 38 between the start point 34 and end point 36 of a ramp 32 of the deformation member 64 will have a diameter 1% less than the diameter at all points along the inclined region 38 between the start point 34 and end point 36 of a ramp 30 of the support sleeve 58.

The engagement surfaces 62,66 of the embodiment of FIG. 4 are arranged and operate as shown in FIGS. 2 and 3 for the embodiment of FIG. 1. In use, the support sleeve 58 is slid over the casing precursor 50 to mate its support surface 60 with the external surface 54 of the casing precursor 50. The internal diameter c of the support 58 is slightly greater than the external diameter b of the casing 50, and so there will be regions where the support surface 54 is not fully engaged with the external surface 54. In order to fill any void between the support surface 60 and external surface 54, the deformation member 64 is located around, and then pushed over the support sleeve 58, for example by a hydraulic press, until it extends over the entire length of the support sleeve 58. The dimensions of the deformation member 64 remain substantially constant, and the support sleeve 58 contracts to allow the deformation member 64 to slide over it. The casing 50, support sleeve 58 and deformation member 64 are co-axially arranged relative to one another, and share a common axis. In axially displacing the support sleeve 58 and deformation member 64 relative to one another, the support sleeve 58 is deformed by the deformation member 64 such that the support surface 60 engages with substantially the whole of the outer surface 54 of the casing precursor 50.

As will be appreciated, the action of the deformation member 64 on the support sleeve 58 is akin to that shown in FIGS. 3a-e, except that the sleeve 58 to caused to radially contract (rather than expand). Thus the action of pushing the non deformable deformation member 64 over the sleeve 58 causes the sleeve 58 to contract radially such that it comes into contact with substantially all of the outer surface 54 of the casing precursor 50. The casing precursor 50 may be elastically deformed by the contraction of the support sleeve 58.

With such support in place, recessed pockets (not shown) may be machined in the internal surface 52 of the casing. The support 58 reacts loads acting on the casing precursor 50 by a machining tool during machining, thereby minimising distortion of the casing 50 and tearing of the pockets being formed.

In one embodiment the casing precursor is formed from a titanium alloy, and the support sleeve and deformation member are made from Chronite. Preferably the support sleeve has a thickness four times that of the casing precursor.

The casing precursor 10,50 may be machined to produce any desired features on the surface 12,52. For example a polygonal isogrid structure may be machined into the surface 12,52. Alternatively or additionally, bosses are provided by the removal of material from the casing precursor 10,50.

1. A method of manufacturing a thin wall isogrid or the like casing by a machining process; the said method comprising the steps of:
mating a surface of a casing precursor with a substantially continuous support surface of a hollow support sleeve;
engaging an engagement surface of a deformation member with an engagement surface of the support sleeve, the engagement surface of the support sleeve being opposite the support surface and the deformation member being co-axially arranged with the support sleeve;
axially displacing the support sleeve and deformation member relative to one another, the deformation member engagement surface and support sleeve engagement surface being configured such that the support sleeve is deformed by the deformation member by the relative axial displacement in order to mate the support surface with substantially the whole of the surface of the casing precursor to be machined; and
machining a plurality of recessed pockets in the said surface of the casing precursor opposite the surface engaged by the said support sleeve; whereby the support sleeve reacts loads acting on the casing precursor by a machining tool during machining, thereby minimising distortion of the casing precursor and tearing of the pockets being formed.

2. A method as claimed in claim 1 wherein the casing precursor is elastically deformed during the mating process with the support sleeve.

3. A method as claimed in claim 1 wherein the casing precursor is substantially cylindrical.

4. A method as claimed in claim 1 wherein the casing precursor is fabricated from sheet metal.

5. A method as claimed in claim 1 wherein the casing precursor is a forged casing precursor.

6. A method as claimed in claim 1 wherein the casing precursor is machined on its radially outer surface and supported by the support sleeve on its radially inner surface.

7. A method as claimed in claim 1 wherein the casing precursor is machined on its radially inner surface and supported by the support sleeve on its radially outer surface.

8. A method as claimed in claim 1 wherein the said pockets are machined to have a radial thickness of less than 1 mm.

9. A method as claimed in claim 8 wherein the said pockets are machined to have a radial thickness substantially in the range 0.45 mm to 0.85 mm.

10. Machining support apparatus for use in manufacturing a thin wall isogrid casing or the like by a machining process as described in claim 1; the said support apparatus comprising:
a hollow support sleeve having a substantially continuous support surface for mating with a surface of a casing precursor, and an engagement surface substantially opposite the support surface;
a deformation member with an engagement surface for coaxial location and engagement with the engagement surface of the support sleeve, the deformation member engagement surface and support sleeve engagement surface being sized such that relative axial displacement of the support sleeve and deformation member will deform the support sleeve;
whereby, in use
a casing precursor is mated with said support sleeve and the deformation member is coaxially engaged with the engagement surface, and the support sleeve and deformation member are axially displaced relative to one another, such that the support sleeve is deformed by the deformation member to engage the support surface with substantially the whole of the surface of the casing precursor to be machined, whereby the support sleeve reacts loads acting on the casing precursor by a machining tool during machining, thereby minimising distortion of the casing precursor and tearing of the pockets being formed.

11. Machining support apparatus as claimed in claim 10 wherein the engagement surfaces of the support sleeve and deformation member comprise at least one ramp, the or each ramp comprising a start point and an end point with an inclined region of increasing height therebetween, the ramp height defined as the difference in diameter between the start point and any point on the inclined surface between the start point and the end point.

12. Machining support apparatus as claimed in claim 10 wherein, in a non deformed state, the support sleeve and deformation member are sized such that there is at least a 1% difference in diameter between any point on the ramp of the engagement surface of the support sleeve and a corresponding point on the ramp on the engagement surface of the deformation member.

13. Machining support apparatus as claimed in claim 11 wherein the ratio of ramp height at the end point to ramp length is in the range of 1:5 to 1:10, where the ramp length is defined as the axial distance between the start point and end point.

14. Machining support apparatus as claimed in claim 11 wherein the engagement surfaces each comprise at least two ramps and the diameter of each start point and each end point of successive ramps on both engagement surfaces is substantially constant along the axial length of the support apparatus.

15. Machining support apparatus as claimed in claim 10 wherein, in a non deformed state, the support sleeve is sized such that there is a clearance gap in the range of 300 μm to 500 μm between the support surface and the casing precursor surface it is to be mated to.
